(19) United States
(12) Patent Application Publication
(10) Pub. No.: US 2015/0007899 A1
(43) Pub. Date: Jan. 8, 2015

(54) FUEL SUMP AND WITHDRAWAL APPARATUS

(71) Applicant: C. Brad Ekstam, Marthasville, MO (US)

(72) Inventor: C. Brad Ekstam, Marthasville, MO (US)

(21) Appl. No.: 14/323,572

(22) Filed: Jul. 3, 2014

Related U.S. Application Data
(60) Provisional application No. 61/842,661, filed on Jul. 3, 2013.

(51) Int. Cl. B60K 15/01; F02M 37/00

(52) U.S. Cl. CPC B60K 15/01; F02M 37/0082
USPC 137/590

(57) ABSTRACT

A fuel sump with a draw tube on the inside of the fuel tank to maximize the fuel available to the engine eliminate an exterior fuel line that would normally be exterior to the fuel tank attached to the fuel sump.

### CROSS-REFERENCE TO RELATED APPLICATION

This application claims the benefit of prior filed, co-pending application Ser. No. 61/842,661, filed Jul. 3, 2013, entitled FUEL SUMP AND WITHDRAWAL APPARATUS.

### FIELD

This invention relates to automotive fuel tank sump systems. More specifically, it relates to a fuel sump in combination with a draw tube to minimize ingesting of air with the fuel and maximize the available fuel.

### BACKGROUND

Diesel fuel engines are notoriously sensitive to entrained air in their fuel lines. Due to how a diesel engine operates, first compressing air in the combustion chamber and then introducing fuel, an elevated level of entrained air in diesel engine supply fuel can have a dramatic impact on engine performance. Air in the fuel line can damage fuel injectors and throw off engine timing. This can result in loss of horsepower, loss of mileage per gallon, and overall inconsistent engine performance. Therefore, to maximize diesel engine performance, the amount of air entrained in the fuel being supplied to the engine should be minimized.

Air bubbles form in diesel fuel lines for a number of reasons, the most common of which is agitation of the fuel while the vehicle is in motion. Diesel fuel dispensed into a vehicle from a fuel pump likely has air present in it, though the air is generally in the form of microscopic bubbles that have not yet materialized into larger more damaging bubbles. Air at the molecular level typically forms into the larger more damaging visible bubbles when the diesel fuel is agitated, such as in a vehicle's fuel tank while the vehicle is in motion.

The desire to keep entrained air quantities low in fuel being supplied to engines has led to the creation and production of high performance fuel air separation systems. Such air separation systems are commonly installed on vehicles or other machines where the associated engine is intended to perform at a high level. The systems serve as a strainer for the fuel before it reaches the engine, removing much of the sediment and entrained air before the fuel is sent to the fuel injectors and combustion chamber. These systems generally comprise a fuel pump, an air separator and, in high flow systems, a vertical draw tube for drawing the fuel from the fuel tank.

A common problem with the draw tube systems is that they perform poorly when the fuel tank is low. Problems generally occur when the tank is one quarter full or less. This is due in large part to the fuel in the tank shifting when the vehicle is in motion and consequently moving away from the intake draw tube. This may result in an inordinate amount of air being sucked into the fuel system, which results in a much larger quantity of air in the fuel supply system than the air separator system can remove. Consequently, even with an air separator system installed, when a draw tube configuration is used and the fuel drops near or below one quarter tank, engine and fuel injector problems still occur.

Fuel tank sump systems can be used in lieu of the draw tube configuration to combat this low fuel level issue. These sump systems generally comprise a fuel sump or container attached to the bottom of a vehicle fuel tank, and a fuel draw tube drawing fuel from the sump. The fuel draw tube typically attaches to the side of the sump on the outside of the fuel tank and serves as the sole fuel withdrawal mechanism for the entire fuel tank. Because the tube is attached to the side of the sump, and the sump is the lowest point in the fuel system, the chance that air will be pulled into the fuel supply system, even at low tank levels, is minimized. The nature of the sump and its associated draw tube is that the inlet of the tube is always flooded as long as there is fuel in the sump.

A problem with this configuration is that the side draw tube is routed along the exterior bottom of the vehicle's fuel tank and is generally fully exposed and unprotected. This tube is often made of flexible rubber hose to make installation easier. Any article that the vehicle drives over could potentially make contact with the exposed fuel draw tube and damage it, or knock it off. This situation could occur when driving over road debris or in off-road conditions such as mounds or ditch embankments, undercarriage car washes, and even vandalism. Therefore, a system is needed that has the functionality of the fuel sump system without the weakness of an exposed fuel line below the vehicle fuel tank.

### SUMMARY

The present invention includes a fuel sump and draw tube on the inside of the fuel tank to maximize the fuel available to the engine and minimize the likelihood of breaking a fuel line that would normally be exterior to the fuel tank attached to the fuel sump.

### BRIEF DESCRIPTION OF THE DRAWINGS

FIG. 1 is a perspective view of a sump withdrawal apparatus installed in a fuel tank.

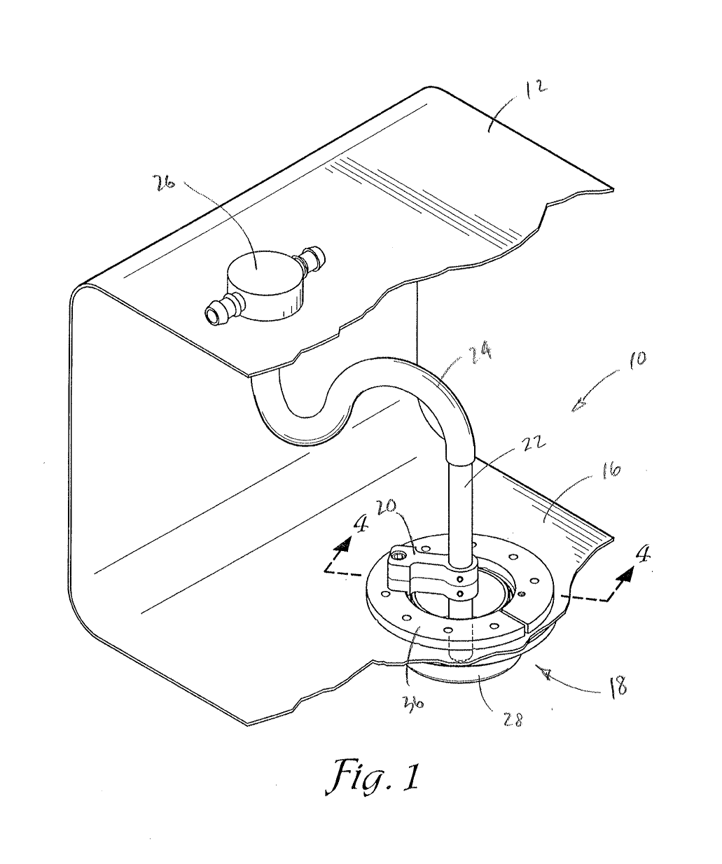

FIG. 2 is an exploded perspective view of a sump withdrawal apparatus installed in a fuel tank.

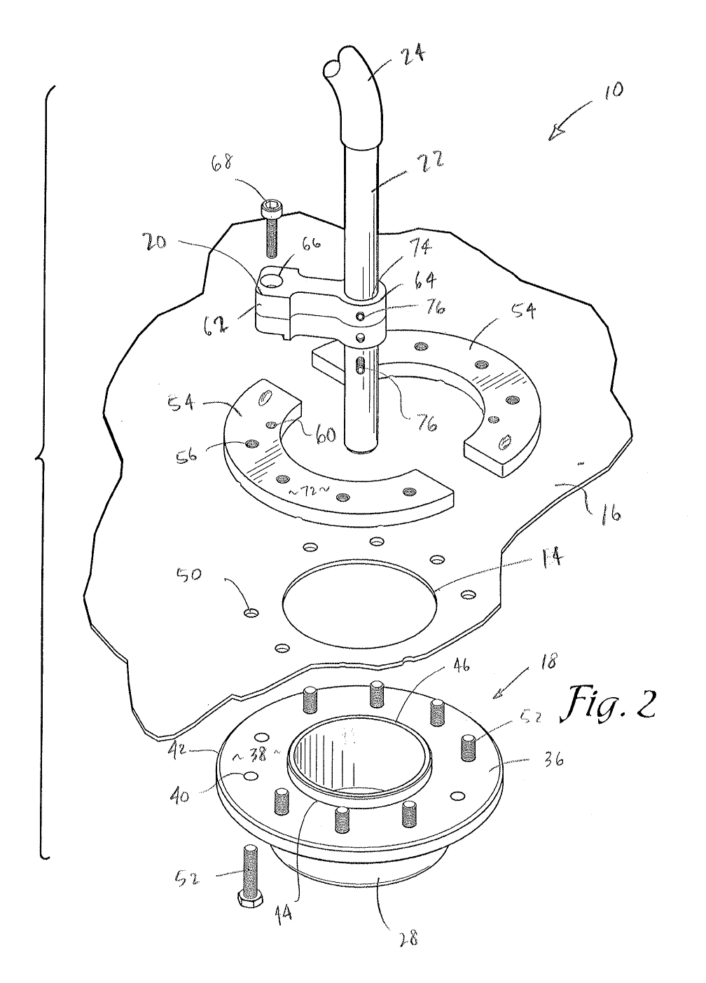

FIG. 3 is a partially exploded bottom perspective of a sump withdrawal apparatus.

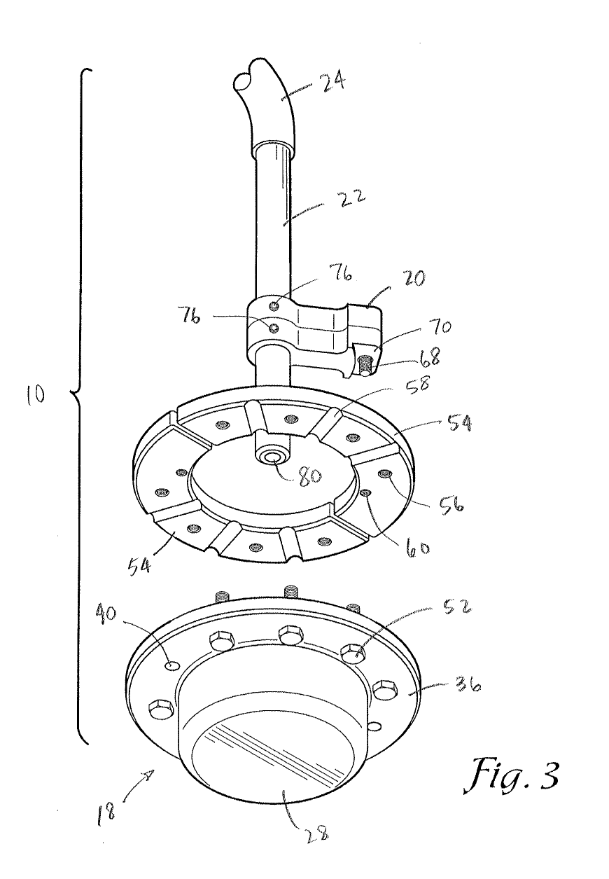

FIG. 4 is a cross sectional view of the sump withdrawal apparatus taken along line 4 of FIG. 1.

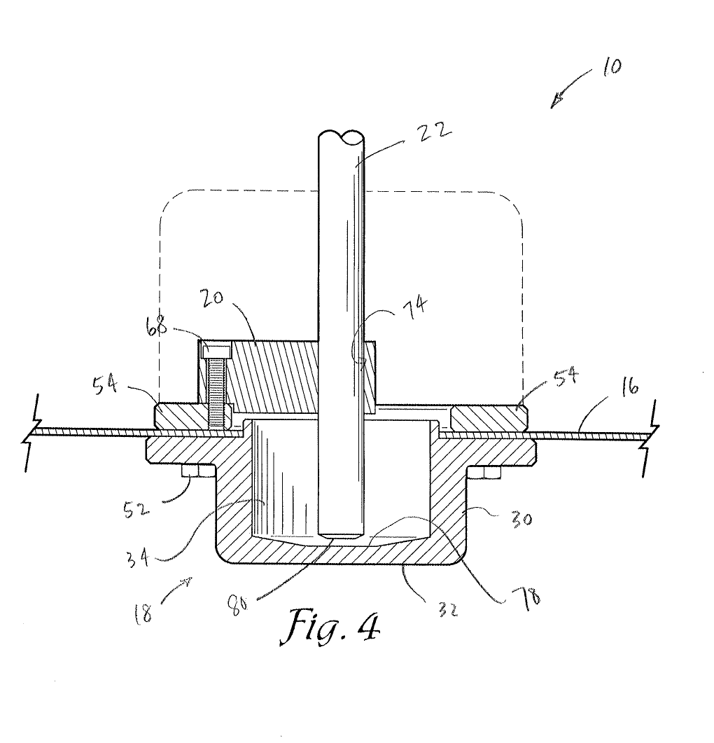

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof

Certain terminology will be used in the following description for convenience in reference only and will not be limiting. For example, the words “upwardly,” “downwardly,” “rightwardly,” and “leftwardly” will refer to the installed position of the item to which the reference is made. The words “inwardly” and “outwardly” will refer to directions toward and away from, respectively, the geometric center of the embodiment being described and designated parts thereof Said terminology will include the words specifically mentioned, derivatives thereof and words of a similar import.

Referring to the drawings in more detail, reference numeral 10 refers to a fuel sump withdrawal apparatus attached to a fuel tank 12 and integrally communicating with the interior of the tank via hole 14 in the floor 16 of the tank. The fuel sump withdrawal apparatus 10 includes a sump 18, a support bracket 20, and a fuel draw tube 22. Fuel sump withdrawal apparatus 10 is typically connected to the vehicle fuel supply system via flexible tube 24. Flexible tube 24 then connects to a fuel distribution tee 26. The remaining portion of the vehicle fuel distribution system also connects to fuel distribution tee 26.

Sump 18 includes a holding vessel 28 with a sidewall 30 and a floor 32 forming an interior cavity 34 for holding fuel. One configuration of the sidewall 28 and floor 32 is a cylindrical shape with sidewall 30 having a curvature and floor 32 having a circular shape. Sidewall 30 extends upwardly from floor 32 to form interior cavity 34. Floor 32 slopes downwardly toward its center.

Sump 18 also has an annular clamping flange 36 at the top of holding vessel 28. Clamping flange 36 includes a planar top surface 38 and an overhang 42 projecting outward from and encircling the top of holding vessel 28. A plurality of fastener holes 40 through clamping flange 36 are located midway between the outer circumferential edge 42 and inner circumferential edge 44 of flange 36, and the fastener holes 40 are equally spaced radially about the entirety of the flange.

Sump 18 further includes a lip 46 at the top of the holding vessel 28 that is adjacent to and rising above the inner circumferential edge 44 of clamping flange 36. Lip 46 aids in installation and alignment of sump 18 within mounting hole 14 in fuel tank 12. When sump 18 is installed, lip 46 is inserted into tank hole 14 such that the lip 46 is immediately adjacent the rim 48 of the tank hole 14. Circumferentially surrounding tank hole 14 is a plurality of mounting holes 50 through tank floor 16, sized so that threaded fasteners 52 can move freely through the mounting holes.

Sump 18 is attached to fuel tank 12 by first placing threaded fasteners 52 through fastener holes 40, then through mounting holes 50, and then threadably engaging clamping band 54 on the interior of tank 12. Clamping band 54 is an arcuate band, which may have an arc of more, less, or equal to one hundred eighty degrees, and the band comprises a plurality of threaded holes 56 for receiving threaded fasteners 52. Clamping band 54 has a plurality of shallow channels 58 arranged transversely across the underside of clamping band 54 in a radial fashion. The shallow channels 58 allow fuel to pass from the outer periphery of the clamping band 54 to the inner periphery and thus into sump 18 when the band 54 is installed. This minimizes the potential that the clamping band 54 will prohibit fuel from reaching the sump 18.

Clamping band 54 is installed inside fuel tank 12, and when threaded fasteners 52 engage threaded holes 56, sump 18 is secured to the exterior of fuel tank 12 with floor 16 being clamped between clamping band 54 and sump 18. It is foreseen that two or more clamping bands 54 may be used to secure sump 18 to the tank 12 depending on the size of the sump and the configuration of the fuel tank. A rubber O-ring or gasket material may be installed between the flange 36 and the fuel tank bottom 16 to prevent fuel leaks.

Clamping band 54 also has a threaded aperture 60 for mounting support bracket 20 to clamping band 54 inside tank 12. Support bracket 20 includes a mounting end 62 and a support end 64. Mounting end 62 has an aperture 66 for receiving a fastener 68 therethrough. The fastener 68 threadably engages the threaded aperture 60 to secure the support arm 20 to the clamping band 54. Mounting end 62 has an inset mounting surface 70 that rests atop clamping band 54 on the band's upper surface 72. Inset mounting surface 70 allows support arm 20 to partially envelop clamping band 54, thus creating a stop against band 54 to prevent support arm 20 from rotating about the fastener 68.

Support end 64 is the distal end of support arm 20 and projects radially inwardly from the clamping band 54 such that support end 64 is located above sump 18 proximate the axial center of sump 18. Support end 64 comprises an open cylinder 74 for holding fuel draw tube 22. Open cylinder 74 includes one or more set screws 76 for securing draw tube 22 at the desired position and height above the bottom 78 of the sump 18.

Fuel draw tube 22 is inserted into open cylinder 74 and positioned to the desired height and set screw 76 is tightened to engage the side of tube 22 to keep it in place. The open end 80 of tube 22 is generally located approximately one-eighth inch above bottom 78 of the holding vessel 28 proximate the center of the bottom 78.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is:

1. A fuel sump withdrawal apparatus for mounting to a fuel tank of a vehicle, said apparatus comprising:
a sump having a holding vessel with an interior cavity for receiving fuel from the fuel tank, said sump extending through an aperture in a floor of the fuel tank; and
a draw tube having an open end extending into said interior cavity of said sump and a second end coupled to a fuel line of said vehicle.

2. The apparatus of claim 1 wherein said interior cavity of said sump includes a floor and a side wall extending upwardly from said floor, said floor sloping downwardly from said side wall to a center area.

3. The apparatus of claim 2 wherein said open end of said draw tube is spaced from said center area of said floor.

4. The apparatus of claim 2 wherein said open end of said draw tube is spaced approximately one-eighth inch from said center area of said floor.

5. The apparatus of claim 1 wherein said sump includes a clamping flange projecting outwardly from and encircling an upper lip of said holding vessel, said clamping flange having a plurality of apertures for receiving fasteners therethrough, said clamping flange configured to engage an exterior surface around the aperture in the floor of the fuel tank, and a clamping band having a plurality of threaded apertures for receiving said fasteners, said clamping band configured to engage an interior surface around the aperture in the floor of the fuel tank.

6. The apparatus of claim 5 wherein said clamping band includes two arcuate bands.

7. The apparatus of claim 5 wherein said clamping band includes one or more channels extending transversely across an underside of said clamping band from an outer periphery to an inner periphery.

8. The apparatus of claim 5 further comprising a gasket material installed between said clamping flange and the exterior surface around the aperture in the floor of the fuel tank.

9. A fuel sump withdrawal apparatus for mounting to a fuel tank of a vehicle, said apparatus comprising:
a holding vessel having side walls and a floor presenting an interior cavity for receiving fuel from the fuel tank, said holding vessel extending through an aperture in a floor of the fuel tank;
a clamping flange projecting outwardly from and encircling an upper lip of said side walls, said clamping flange having a plurality of apertures for receiving fasteners therethrough, said clamping flange configured to engage an exterior surface around the aperture in the floor of the fuel tank;
a clamping band having a plurality of threaded apertures for receiving said fasteners, said clamping band configured to engage an interior surface around the aperture in the floor of the fuel tank; and
a draw tube having an open end extending into said interior cavity of said sump and a second end coupled to a fuel line of said vehicle.

10. The apparatus of claim 9 wherein said floor of said holding vessel slopes downwardly from said side walls to a center area.

11. The apparatus of claim 10 wherein said open end of said draw tube is spaced from said center area of said floor.

12. The apparatus of claim 10 wherein said open end of said draw tube is spaced approximately one-eighth inch from said center area of said floor.

13. The apparatus of claim 9 further comprising a support bracket having a mounting end fastened to said clamping band and a support end having an open cylinder for receiving said draw tube and securing said draw tube in place.

14. The apparatus of claim 13 wherein said support end includes a set screw for adjustably securing said draw tube in place.

15. The apparatus of claim 9 wherein said clamping band includes one or more channels extending transversely across an underside of said clamping band from an outer periphery to an inner periphery.

16. The apparatus of claim 9 further comprising a gasket material installed between said clamping flange and the exterior surface around the aperture in the floor of the fuel tank.

17. A fuel sump withdrawal apparatus for mounting to a fuel tank of a vehicle, said apparatus comprising:
a holding vessel having side walls and a floor sloping downwardly from said side walls to a center area and presenting an interior cavity for receiving fuel from the fuel tank, said holding vessel extending through an aperture in a floor of the fuel tank;
a clamping flange projecting outwardly from and encircling an upper lip of said side walls, said clamping flange having a plurality of apertures for receiving fasteners therethrough, said clamping flange configured to engage an exterior surface of the fuel tank around the aperture in the floor of the fuel tank;
a clamping band having a plurality of threaded apertures for receiving said fasteners and one or more channels extending transversely across an underside of said clamping band from an outer periphery to an inner periphery of said clamping band, said clamping band configured to engage an interior surface of the fuel tank around the aperture in the floor of the fuel tank;
a gasket material installed between said clamping flange and the exterior surface of the fuel tank around the aperture in the floor of the fuel tank; and
a draw tube having an open end extending into said interior cavity of said sump and spaced from said center area of said floor, and a second end coupled to a fuel line of said vehicle.

18. The apparatus of claim 17 wherein said open end of said draw tube is spaced approximately one-eighth inch from said center area of said floor.

19. The apparatus of claim 17 further comprising a support bracket having a mounting end fastened to said clamping band and a support end having an open cylinder for receiving said draw tube and securing said draw tube in place.

20. The apparatus of claim 19 wherein said support end includes a set screw for adjustably securing said draw tube in place.
